(19) United States
(12) Patent Application Publication
(10) Pub. No.: US 2003/0082424 A1
(43) Pub. Date: May 1, 2003

(54) Vehicle having an energy store, and a method for operating the vehicle

(76) Inventors: Christian Kohrs, Waiblingen (DE); Juegen Trost, Grafenberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/256,257

(22) Filed: Sep. 27, 2002

(30) Foreign Application Priority Data
Sep. 28, 2001 (DE) 101 48 113.6

(51) Int. Cl. H01M 4/00

(52) U.S. Cl. 429/27

(57) ABSTRACT

A vehicle having a drive unit, a drive train, at least one driven wheel, an energy storage means and power electronics for supplying electrical loads in the vehicle. An electrical machine is electrically connected to the power electronics, which are electrically connected to an electrolyzer. One output of the electrolyzer is connected via a media line to an energy store, and one input of the electrolyzer is connected to a water tank. The storage contents of the energy store are supplied to a fuel cell system and/or to the drive unit for power production.

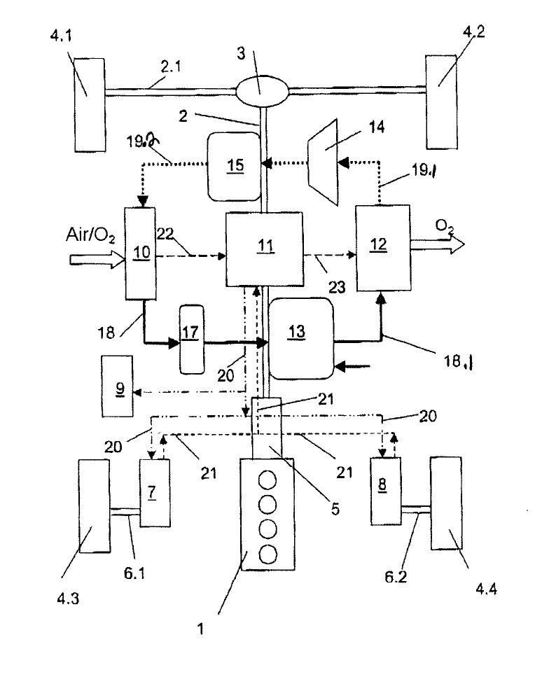

### BACKGROUND AND SUMMARY OF THE INVENTION

This application claims the priority of German Patent Document No. 101 48 113.6, filed Sep. 28, 2001, the disclosure of which is expressly incorporated by reference herein.

The invention relates to a vehicle having an energy store, and to a method for operating the vehicle.

When braking a vehicle for speed adaptation or for driving down gradients, the kinetic and/or potential energy of the vehicle must be dissipated. The normal driving brakes and retarders convert this energy into heat during braking. It has already been proposed, for hybrid vehicles with electrical machines in the drive train, for such braking energy to be recuperated and, for example, for the electrical machine to be operated as a generator. Since it is virtually impossible to consume the recuperated energy in large amounts again at the same time that it is produced, for example in secondary loads, the energy must be fed into a storage medium. Various possibilities have been proposed for storing the energy, including batteries of various technologies, capacitors and electrical or mechanical flywheels.

However, none of the three storage technologies allows storage with a sufficiently high energy density and with a high power density at the same time. That is, only small amounts of energy can be stored, or else the storage unit is large, heavy and expensive, and this can considerably exceed its usefulness.

The invention is based on the object of specifying a vehicle in which the recuperation of braking energy from the vehicle is made possible by an improved energy and power density, and by specifying a method for operating the vehicle.

According to the invention, electrical energy, which is obtained from braking energy, is used for electrolysis of water. The hydrogen can be stored. The hydrogen which is obtained from the electrolysis can be used to operate a fuel cell system. The high power density of the hydrogen can be advantageously used for storage of the braking energy.

Other objects, advantages and novel features of the present invention will become apparent from the following detailed description of the invention when considered in conjunction with the accompanying drawings.

### BRIEF DESCRIPTION OF THE DRAWING

The invention will be explained in more detail with reference to a drawing, using a single FIGURE.

The FIGURE shows a schematic illustration of one preferred refinement of a vehicle according to the invention.

### DETAILED DESCRIPTION OF THE DRAWINGS

The invention is particularly suitable for vehicles equipped with a fuel cell system, which provides electrical energy for secondary units. Such a fuel cell system is also referred to as an auxiliary power unit (APU). Its use is particularly advantageous in vehicles with internal combustion engines, which are supplied with hydrogen as the fuel. However, the invention may also be used in vehicles which are driven by the energy from a fuel cell system.

The FIGURE shows a schematic illustration of one preferred refinement of a vehicle according to the invention. A drive unit 1, preferably an internal combustion engine, is connected via a gearbox 5 to a drive train 2, which has a conventional differential 3 and drive shaft 2.1 for two driven wheels 4.1, 4.2. Two further wheels 4.3, 4.4 are not driven directly by the drive unit 1.

Power electronics 11, which may be connected to a conventional battery, supply electrical power to loads 9.

Furthermore, the power electronics 11 may supply electrical power to electrical machines 6, 7 which are connected to the wheels 4.3, 4.4, which are not driven by the drive unit 1, for drive purposes. This is indicated by a line 20 in the FIGURE. The electrical machines 7, 8 may also drive the wheels 4.3, 4.4 during normal driving operation.

During braking processes, the required braking torque is at least partially produced via one or more electrical machines 7, 8.

The electrical current, which is produced in the generator mode, is supplied via the power electronics 11, as is indicated by a line 21 in the FIGURE. This electrical power is supplied via the power electronics 11 to an electrolyzer 12. This is indicated by the dashed line 23 in the FIGURE.

The electrolyzer 12 uses this electrical energy to produce hydrogen, by decomposing water into hydrogen and oxygen. The water is supplied to the electrolyzer 12 via a first media line 18.1 from a water tank 13. The oxygen which is released can be emitted into the environment, or can be stored.

The hydrogen which is produced is supplied via a second media line 19.1 to an energy store 15, a hydrogen store. In this case, hydrogen is used here as the storage medium, with which the energy store 15 is filled. The energy store 15 is preferably in the form of a pressurized tank. For this purpose, the electrolysis can itself be carried out at an appropriate pressure, or a compressor 14, which is arranged between the electrolyzer 12 and the energy store 15 in the media line 19.1, compresses the hydrogen to a desired pressure.

In one advantageous embodiment, the stored hydrogen can be supplied to the drive unit 1 when an internal combustion engine is used. In this case, the water tank 13 must be replenished from time to time. This is indicated in the FIGURE by an arrow pointing at the water tank 13.

In one particularly preferred refinement, the hydrogen is supplied via a third media line 19.2 to a fuel cell unit in the fuel cell system 10, as a fuel. The fuel cell unit converts hydrogen and oxygen to water, with electrical power being produced.

No details are illustrated of the fuel cell system 10, such as the oxygen supply or fuel cell cooling, or any exhaust gas recirculation. The fuel cell system 10 preferably has a fuel cell unit with a polymer electrolyte membrane. Air may be used as the oxygen source and, if necessary, is compressed to an appropriate pressure, and is supplied to the cathode of the fuel cell unit. Additionally or alternatively, oxygen may also be supplied from the electrolyzer. The hydrogen is supplied to the anode of the fuel cell unit. The fuel cell exhaust gas essentially contains water and hydrogen, and can be supplied to the anode once again. Water is preferably precipitated from the fuel cell exhaust gas in a condenser 17, and is supplied to the water tank 13. With appropriate process control, for example with adequate water being formed in the fuel cell reaction, the circuit can be designed such that the hydrogen and water circuit essentially forms a closed loop.

The electrical power which is provided by the fuel cell system 10 is then available to be supplied to the loads 9 and to the drive in the electrical machines, or else for starting the drive unit 1. This is illustrated in the FIGURE by means of a dashed line 22 between the fuel cell system 10 and the power electronics 11.

The drive unit 1 may also be an electrical machine, which is supplied with electrical power from a traction battery or from an appropriately high-power fuel cell system.

In the case of an internal combustion engine drive, the electrical machine 7, 8 may act as a wheel drive in the way indicated in the FIGURE, or else may be arranged upstream of or downstream from the gearbox 5 in the drive train 2, as is known from hybrid drives with an internal combustion engine and an electrical machine. It is thus possible, for example, to arrange an electrical machine 7, 8 in the drive train 2 between the drive unit 1 and the gearbox 5.

Since an electrical machine 7, 8 feeds electrical energy into an electrolyzer 12, as a generator, during braking of the vehicle, the braking energy can be stored with a high power density in the form of hydrogen.

When the vehicle is being driven by the internal combustion engine, then the hydrogen may also be used for combustion, or, in the case of a hybrid drive with an internal combustion engine and an electrical machine, an additional drive energy may be provided via the fuel cell system 10 and the electrical machine 7, 8 and, furthermore, which can also be used over lengthy time periods.

The internal combustion engine drive can be designed to be light and cost effective, and may compensate for a proportion of the cost required for the recuperation unit.

In addition to saving drive energy, the invention allows driving without any exhaust gas and with virtually no noise in population centers. Any interruption in the traction force during acceleration or switching can be reduced, or even avoided, by the drive support (boost function) from the electrical machine 7, 8. A sufficiently large amount of electrical power is available for loads 9, and the loads 9 may also be supplied when the vehicle is stationary. In this case, further loads outside the vehicle may also be supplied.

It is likewise possible to provide all-wheel drive functions, in which case the wheels can be driven by electrical machines which are in turn supplied by the fuel cell system 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle having a drive unit, a drive train, at least one driven wheel, an energy store and power electronics for supplying electrical loads in the vehicle, said vehicle further comprising;
an electrical machine electrically connected to the power electronics;
an electrolyzer electrically connected to said power electronics;
a media line connecting one output of the electrolyzer to the energy store;
a water tank connected to one input of the electrolyzer to a water;
wherein storage contents of the energy store are supplied to at least one of a fuel cell system and the drive unit for power production.

2. The vehicle according to claim 1, wherein
a fuel cell exhaust gas line from the fuel cell system is connected via said media line to the water tank.

3. The vehicle according to claim 1, wherein
a compressor is arranged in the media line between the electrolyzer and the energy store.

4. The vehicle according to claim 1, wherein
a condenser is arranged in the media line between the fuel cell unit and the water tank.

5. The vehicle according to claim 1, wherein
the electrical machine is operatively connected to drive said at least one driven wheel.

6. The vehicle according to claim 1, wherein
the electrical machine is arranged one of upstream of and downstream from a gearbox in the drive train.

7. The vehicle according to claim 1, wherein
the electrical machine is arranged in the drive train between the drive unit and the gearbox.

8. The vehicle according to claim 1, wherein
the drive unit is an internal combustion engine.

9. The vehicle according to claim 1, wherein
the drive unit is an electrical machine.

10. A method for operating a vehicle which has a drive unit, a drive train, a least one driven wheel, an energy store and power electronics for supplying electrical loads in vehicle, said method comprising the steps of:
operating an electrical machine as a generator for feeding electrical power into said power electronics during braking of said vehicle;
outputting said electrical power from said power electronics to an electrolyzer; and
supplying from said electrolyzer a storage medium to fill said energy store.

11. The method according to claim 10, wherein said storage medium is hydrogen which is produced by said electrolyzer and stored in said energy store.

12. The method according to claim 11, wherein said hydrogen is supplied to a fuel cell unit in order to produce electrical power.

13. The method according to claim 11, wherein said hydrogen is supplied to the drive unit for combustion.

14. The method according to claim 12, wherein water is collected from an exhaust gas of the fuel cell and is supplied to a water tank.

15. The method according to claim 10, wherein a fuel cell system supplies electrical power to at least one said electrical loads and said electrical machine.

16. The method according to claim 10, comprising the further step of collecting water from an exhaust gas from a fuel cell and supplying said water to a water tank.

17. The method according to claim 11, comprising the further step of collecting water from an exhaust gas from a fuel cell and supplying said water to a water tank.

18. The method according to claim 11, wherein a fuel cell system supplies electrical power to at least one said electrical loads and said electrical machine.

19. The method according to claim 12, wherein a fuel cell system supplies electrical power to at least one said electrical loads and said electrical machine.

20. The method according to claim 13, wherein a fuel cell system supplies electrical power to at least one said electrical loads and said electrical machine.
